(19) United States
(12) Patent Application Publication
(10) Pub. No.: US 2020/0327586 A1
(43) Pub. Date: Oct. 15, 2020

(54) System, Devices, and Methods for Crowd Based Rating

(71) Applicants: Zane Bowman Allen Miller, Seattle, WA (US); Roy P Diaz, Seattle, WA (US)

(72) Inventors: Zane Bowman Allen Miller, Seattle, WA (US); Roy P Diaz, Seattle, WA (US)

(21) Appl. No.: 16/847,571

(22) Filed: Apr. 13, 2020

Related U.S. Application Data
(63) Continuation of application No. 62/833,697, filed on Apr. 14, 2019.

(51) Int. Cl. G06Q 30/02; G06F 16/9535; G06N 20/00; G06N 5/04

(52) U.S. Cl. CPC G06Q 30/0282; G06F 16/9535; G06F 3/0482; G06N 20/00; G06N 5/04; G06Q 30/0203

(57) ABSTRACT

Systems, devices, and methods are described for allowing users to, among other things, rate specific occurrences of an event, including receiving one or more inputs associated with an event; generating a user interface presenting a rating menu and receiving one or more inputs indicative of a rating associated with the event based on the rating menu; and generating event rating information based on receiving the one or more inputs indicative of the rating associated with the event.

### RELATED APPLICATIONS

This application claims the benefit of priority under 35 USC § 119(e) of U.S. Provisional Patent Application No. 62/833,697 filed Apr. 14, 2019, the contents of which are incorporated herein by reference in their entirety.

### SUMMARY

In an aspect, the present disclosure is directed to, among other things, a device including means for receiving one or more inputs associated with an event. In an embodiment, the device includes means for generating a user interface presenting a rating menu and receive one or more inputs indicative of a rating associated with the event based on the rating menu. In an embodiment, the device includes means for generating event rating information based on receiving the one or more inputs indicative of the rating associated with the event. In an embodiment, the device includes means for receiving crowdsourced event rating information associated with a plurality of users from a remote network. In an embodiment, the device includes means for exchanging event rating information with a remote network.

In an aspect, the present disclosure is directed to, among other things, a device including event circuitry configured to receive one or more inputs associated with an event. In an embodiment, the device includes menu circuitry configured to generate a user interface presenting a rating menu and receive one or more inputs indicative of a rating associated with the event based on the rating menu. In an embodiment, the device includes user rate circuitry configured to generate event rating information based on receiving the one or more inputs indicative of the rating associated with the event. In an embodiment, the device includes crowdsourced event circuitry configured to receive crowdsourced event rating information associated with a plurality of users from a remote network. In an embodiment, crowdsourced information includes data, information, etc., obtained from a large group of people who submit their data via the Internet, smartphone apps, client devices, social media, and the like. In an embodiment, the device includes crowdsourced event circuitry configured to exchange event rating information with a remote network.

In an aspect, the present disclosure is directed to, among other things, a system including circuitry configured to receive crowdsource data from a plurality of remote devices (e.g., remote client devices, mobile devices, cell phone devices, computer devices, desktop computer devices, internet of things (IoT) devices, laptop computer devices, managed node devices, mobile client devices, notebook computer devices, remote controllers, smart devices, smart eyewear devices, smart wearable devices, tablet devices, smart televisions, wearable devices, and the like). In an embodiment, the system includes circuitry configured to generate embellishment data using the crowdsourced data. In an embodiment, the system includes circuitry to exchange embellishment data with one or more remote devices. In an embodiment, the system includes circuitry configured to change an embellishment status using the crowdsourced data.

In an aspect, the present disclosure is directed to, among other things, a system including circuitry configured to acquire event rating information from a plurality of remote devices. In an embodiment, the system includes circuitry configured to generate crowdsourced event rating information associated with the acquired event rating information from the plurality of remote devices. In an embodiment, the system includes circuitry configured to initiate one or more push notices representing a crowdsourced rating associated with the event.

In an aspect, the present disclosure is directed to, among other things, a device including circuitry for receiving one or more inputs associated with a sporting event. In an embodiment, the device includes circuity for generating embellishment data responsive to receiving one or more inputs associated with the sporting event. In an embodiment, the device includes circuity for exchanging embellishment data with a remote network. In an embodiment, the device includes circuitry for updating an embellishment status responsive to exchanging embellishment data with the remote network.

In an aspect, the present disclosure is directed to, among other things, a system, including a crowdsource event module configured to generate a user interface presenting a crowdsourced event menu and to receive one or more inputs indicative of an assessment associated with an event. In an embodiment, the system includes an event classifier module configured to generate crowdsourced classification information based on receiving the one or more inputs indicative of the assessment associated with the event. In an embodiment, the system includes a virtual display module configured to generate a virtual representation of the crowdsource classification information associated with the event.

In an aspect, the present disclosure is directed to, among other things, a method to allow users to rate specific occurrences of an event. In an embodiment, the method includes receiving one or more inputs associated with an event. In an embodiment, the method includes generating a user interface presenting a rating menu and receiving one or more inputs indicative of a rating associated with the event based on the rating menu. In an embodiment, the method includes generating event rating information based on receiving the one or more inputs indicative of the rating associated with the event. In an embodiment, the method includes exchanging event rating information with a remote network. In an embodiment, the method includes receiving crowdsourced event rating information associated with a plurality of users from a remote network. In an embodiment, the method includes generating a display indicative of crowdsourced event rating information based on receiving crowdsourced event rating information associated with a plurality of users from the remote network.

In an aspect, the present disclosure is directed to, among other things, a method including receiving one or more inputs associated with a sporting event. In an embodiment, receiving the one or more inputs associated with the sporting event includes receiving one or more inputs by a user about at least one participant in the sporting event. In an embodiment, the method includes generating embellishment data responsive to receiving one or more inputs associated with the at least one participant in a sporting event. In an embodiment, the method includes exchanging embellishment data with a remote network.

In an aspect, the present disclosure is directed to, among other things, a method of rating specific occurrences at sporting events. In an embodiment, the method includes receiving crowdsource data from a plurality of mobile device. In an embodiment, the method includes generating embellishment data using the crowdsourced data. In an embodiment, the method includes exchanging embellishment data with one or more remote devices.

In an aspect, the present disclosure is directed to, among other things, a sporting event rating device including means for receiving crowdsource data from a plurality of remote devices. In an embodiment, the sporting event rating device includes means for generating embellishment data using the crowdsourced data. In an embodiment, the sporting event rating device includes means for exchanging embellishment data with one or more remote devices.

In an aspect, the present disclosure is directed to, among other things, a system, including an embellishment prediction unit including computational circuitry configured to apply a deep learning classifier to generate prediction scores for a presence of embellishment features of a participant captured in an event digital content. In an embodiment, the system includes a wuss prediction unit including computational circuitry configured to generate a virtual display of embellishment data based on the prediction scores for the presence of embellishment features.

In an aspect, the present disclosure is directed to, among other things, a method, including applying a deep learning classifier to event digital content to obtain prediction scores for the presence of embellishment features of a participant captured in the event digital content. In an embodiment, the method includes generating a virtual representation of embellishment data based on the prediction scores for the presence of embellishment features.

### BRIEF DESCRIPTION OF THE FIGURES

FIG. 1A is a perspective view of a system according to an embodiment.

FIG. 1B is a perspective view of a device according to an embodiment.

FIG. 1C is a perspective view of a device according to an embodiment.

FIGS. 2A-2E are perspective views of a device according to an embodiment.

FIGS. 3A and 3B show a flow diagram of a method according to an embodiment.

FIG. 4 shows a flow diagram of a method according to an embodiment.

FIG. 5 shows a flow diagram of a method according to an embodiment.

FIG. 6 shows a flow diagram of a method according to an embodiment.

FIG. 7 is a perspective view of a system according to an embodiment.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

### DETAILED DESCRIPTION

Described are one or more methodologies or technologies for allowing users to rate specific occurrences of an event. Also described are one or more methodologies or technologies for enabling viewers and fans to interact directly with media broadcasts of any given event (e.g., sporting event, concert, political event, a broadcasted event, etc.,), allowing them to answer polls, view replays, judge calls, etc., all in real time as events happen, on a mobile phone, client device, IoT device, virtual display, smart TV, monitor, etc. In an embodiment, described are one or more methodologies or technologies that are configured to allow media producers to push custom questions and polls to users, subscribers, members, etc., along with any associated video or other content, collate the responses and display the results in real time during a broadcast. In an embodiment, data can be archived, polled, collected, analyzed by a client application at any time during or after a given event, allowing for persistent, fan-based rankings of, for example, players, officials, fouls, calls, falls or any other possible option that can be conceived of by the producer or user base. In an embodiment, a more involved, engaged, and loyal fan base is cultivated.

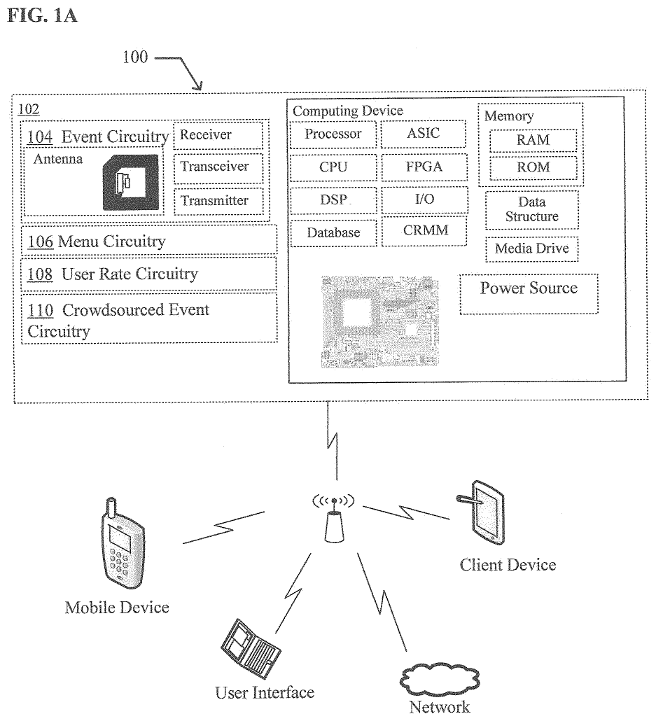

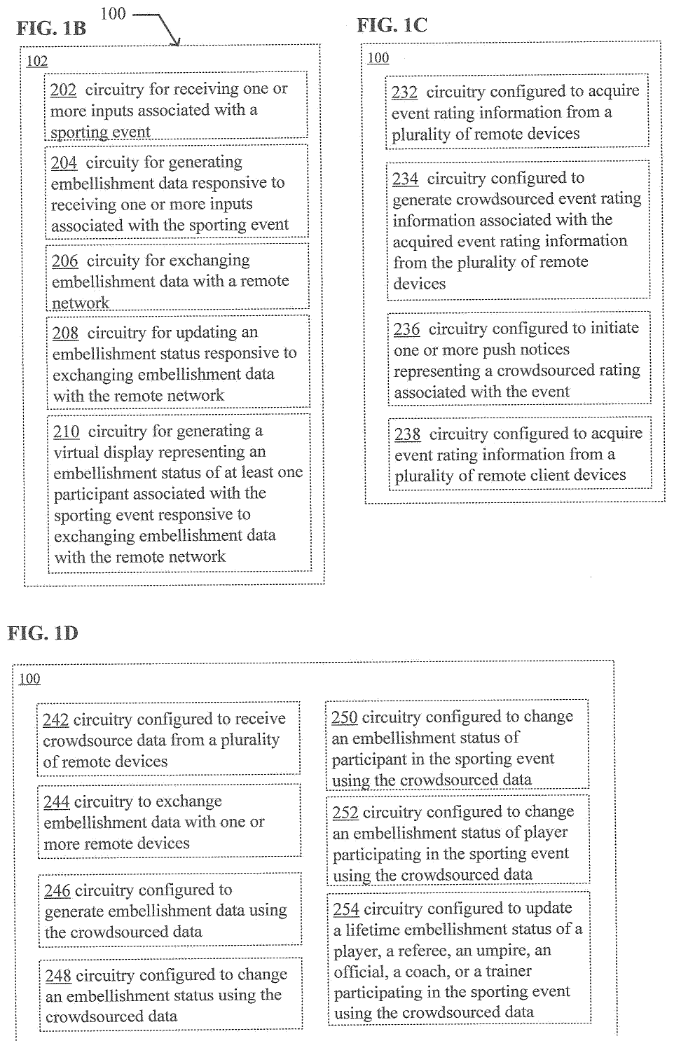

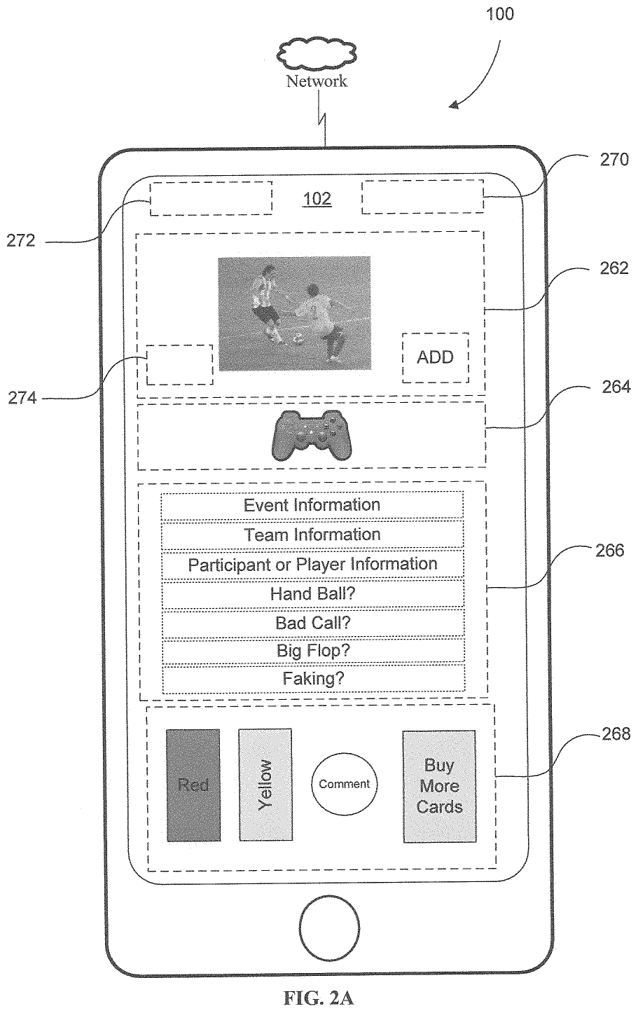

FIG. 1A shows a system 100 (e.g., an event rating system, a crowdsourced event rating network, a system for receiving crowdsourcing data from a plurality of remote devices, or the like) in which one or more methodologies or technologies can be implemented such as, for example, rating specific occurrences at sporting events, or the like. In an embodiment, the system 100 includes a device 102 including event circuitry 104 configured to receive one or more inputs associated with an event.

In an embodiment, aspects of the present disclosure may take the form of a system, device, method, computer program product, etc. In an embodiment, aspects of the present disclosure may take the form of hardware, software (including firmware, resident software, micro-code, etc.), or combinations thereof, all generally be referred to as a “circuit,” “module,” or “system.” (See e.g., U.S. Pat. No. 9,536,194; incorporated herein by reference in its entirety).

In an embodiment, a module includes hardware, software components, or any combination thereof. In an embodiment, one or more of the modules take the form of hardware components (e.g., inductors, capacitors, switches, solid state components, photocells, etc.) located onboard or offboard. In an embodiment, one or more of the modules take the form of computer code modules (e.g., executable code, object code, source code, script code, machine code, etc.) configured for execution by an onboard or offboard processor.

In an embodiment, aspects of the present disclosure may take the form of a computer program product embodied in one or more computer readable medium having computer readable program code embodied thereon.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, circuitry includes one or more ASICs having a plurality of predefined logic components. In an embodiment, circuitry includes one or more FPGA having a plurality of programmable logic components. In an embodiment, circuitry includes one or more remotely located components. In an embodiment, remotely located components are operably coupled via wireless communication. In an embodiment, remotely located components are operably coupled via one or more receivers, transceivers, or transmitters, or the like.

In an embodiment, circuitry includes one or more memory devices that, for example, store instructions or data. For example, in an embodiment, event circuitry 104 configured to receive one or more inputs associated with an event includes one or more memory devices that store one or more parameters associated with receiving the one or more inputs associated with an event, and the like.

Non-limiting examples of one or more memory devices include volatile memory (e.g., Random Access Memory (RAM), Dynamic Random-Access Memory (DRAM), or the like), non-volatile memory (e.g., Read-Only Memory (ROM), Electrically Erasable Programmable Read-Only Memory (flash memory), or the like), persistent memory, or the like. The one or more memory devices can be coupled to, for example, one or more computing devices by one or more instruction, data, or power buses.

In an embodiment, where applicable, circuitry includes peripheral devices such as Bluetooth, Wi-Fi, USB, and cellular connectivity to exchange data, exchange control commands, configure the device, and remotely monitor device parameters. In an embodiment, circuitry includes one or more user input/output components that are operably coupled to the device to generate a user interface that enables access to all user configurable parameters.

In an embodiment, circuitry includes computing circuitry, memory circuitry, electrical circuitry, electro-mechanical circuity, control circuitry, transceiver circuitry, transmitter circuitry, receiver circuitry, and the like. For example, in an embodiment, event circuitry 104 configured to receive one or more inputs associated with an event includes computing device circuitry, memory circuitry, and at least one of transceiver circuitry, transmitter circuitry, and receiver circuitry.

In an embodiment, the device 102 includes menu circuitry 106 configured to generate a user interface presenting a rating menu and receive one or more inputs indicative of a rating associated with the event based on the rating menu. In an embodiment, the device 102 includes user rate circuitry 108 configured to generate event rating information based on receiving the one or more inputs indicative of the rating associated with the event. In an embodiment, the device 102 includes crowdsourced event circuitry 110 configured to receive crowdsourced event rating information associated with a plurality of users from a remote network. In an embodiment, the crowdsourced event circuitry is configured to exchange event rating information with a remote network.

Referring to FIG. 1B, in an embodiment, the device 102 includes circuitry 202 for receiving one or more inputs associated with a sporting event. In an embodiment, the device 102 includes circuitry 204 for generating embellishment data responsive to receiving one or more inputs associated with the sporting event. In an embodiment, the device 102 includes circuitry 206 for exchanging embellishment data with a remote network.

In an embodiment, the device 102 includes circuitry 208 for updating an embellishment status responsive to exchanging embellishment data with the remote network. In an embodiment, the circuitry for updating the embellishment status includes circuitry for updating a faking level for at least one participant associated with the sporting event. In an embodiment, the circuitry for updating the embellishment status includes circuitry for updating a shame rating for at least one participant associated with the sporting event. In an embodiment, the circuitry for updating the embellishment status includes circuitry for updating an embellishment score associated with the sporting event. In an embodiment, the circuitry for updating the embellishment status includes circuitry for updating a flopper status associated with the sporting event. In an embodiment, the circuitry for updating the embellishment status includes circuitry for updating a wuss status for at least one participant associated with the sporting event.

In an embodiment, the device 102 includes circuitry 210 for generating a virtual display representing an embellishment status of at least one participant associated with the sporting event responsive to exchanging embellishment data with the remote network. In an embodiment, the circuitry for generating the virtual display representing the embellishment status of at least one participant associated with the sporting event includes for circuitry for generating a virtual display representing at least one of a faking level, a shame rating, an embellishment score, a flopper status, and a wuss status for at least one participant associated with the sporting event.

In an embodiment, a sporting event rating device, includes means for receiving crowdsource data from a plurality of remote devices. In an embodiment, the sporting event rating device includes means for generating embellishment data using the crowdsourced data. In an embodiment, the sporting event rating device includes means for exchanging embellishment data with one or more remote devices.

Referring to FIG. 1C, in an embodiment, a system 100 includes circuitry 232 configured to acquire event rating information from a plurality of remote devices.

In an embodiment, the circuitry configured to acquire event rating information from the plurality of remote devices includes circuitry configured to acquire event rating information associated with a participant in the event.

In an embodiment, the system 100 includes circuitry 234 configured to generate crowdsourced event rating information associated with the acquired event rating information from the plurality of remote devices. In an embodiment, the circuitry configured to generate crowdsourced event rating information includes circuitry configured to generate a crowdsourced review status of at least one participant associated with the event.

In an embodiment, the system 100 includes circuitry 236 configured to initiate one or more push notices representing a crowdsourced rating associated with the event. In an embodiment, the system 100 includes circuitry 238 circuitry configured to acquire event rating information from a plurality of remote client devices. Non-limiting examples of client devices include application interface with smart devices, cell phone devices, computer devices, desktop computer devices, internet of things (IoT) devices, laptop computer devices, managed node devices, mobile client devices, notebook computer devices, remote controllers, smart devices, smart eyewear devices, smart wearable devices, tablet devices, wearable devices, and the like.

In an embodiment, the system 100 includes circuitry configured to generate a display of archived digital information of a similar nature (e.g., a fall, a bad call, faked injury, faked offense, etc.) or of the same person (e.g., player, coach, referee, etc.). In an embodiment, 100 includes circuitry configured to generate a display indicative of a comparison score between a current event (e.g., a foul, a referee call, etc.) and past digital information.

During operation, in an embodiment, the system 100 is configured to generated, recommend, or virtually displayed additional archived digital content (e.g., archived video, archived images, archived crowdsourced data, or the like) to reinforce the confidence of the user that they were right. In an embodiment, based on how the user rates the play (e.g., fall, bad call, funny, etc.), the system 100 includes circuitry configured to retrieve, display, recommend, or the like to the user additional archived digital content (e.g., plays) to reinforce the user's inputted rating associated with the event based, to corroborate the user inputted impression, to validation user's input or opinion, or the like.

In an embodiment, the system 100 includes computational circuitry configured to provide one or more instances of menus, user input, user interfaces, or the like to allow users to convert digital content, selected plays, event information, or the like to an account avatar, application (App) background, phone background, screen saver, Internet meme, Vine meme, digital meme, or the like.

In an embodiment, the system 100 includes computational circuitry configured to generate, display, provide, recommend, or the like additional archived plays for additional entertainment value, based on how the user rates the event.

Referring to FIG. 1D, in an embodiment, a system 100 includes circuitry configured to receive crowdsource data from a plurality of remote devices (e.g., client devices, mobile devices, cell phone devices, computer devices, desktop computer devices, internet of things (IoT) devices, laptop computer devices, managed node devices, mobile client devices, notebook computer devices, remote controllers, smart devices, smart eyewear devices, smart wearable devices, tablet devices, smart televisions, wearable devices, and the like). In an embodiment, the system 100 includes circuitry 242 configured to generate embellishment data using the crowdsourced data from a plurality of remote devices. In an embodiment, the system 100 includes circuitry 244 to exchange embellishment data with one or more remote devices. For example, the system 100 includes circuitry 244 to exchange embellishment data with one or more mobile devices.

In an embodiment, the system 100 includes circuitry 246 configured to generate embellishment data using the crowdsourced data. In an embodiment, the system 100 includes circuitry 248 configured to change an embellishment status of a participant in the sporting event using the crowdsourced data. In an embodiment, the system 100 includes circuitry 250 configured to change an embellishment status of participant in the sporting event using the crowdsourced data. In an embodiment, the system 100 includes circuitry 252 configured to update a lifetime embellishment status of a player, a referee, an umpire, an official, a coach, a manager, or a trainer participating in the sporting event using the crowdsourced data. In an embodiment, the system 100 includes circuitry 254 configured to update in real time an embellishment status of player, a referee, an umpire, an official, a coach, or a trainer participating in a sporting event using the crowdsourced data. In an embodiment, the system 100 includes circuitry configured to update in real time an embellishment status of player, a referee, an umpire, an official, a coach, or a trainer participating in a broadcasted event using the crowdsourced data.

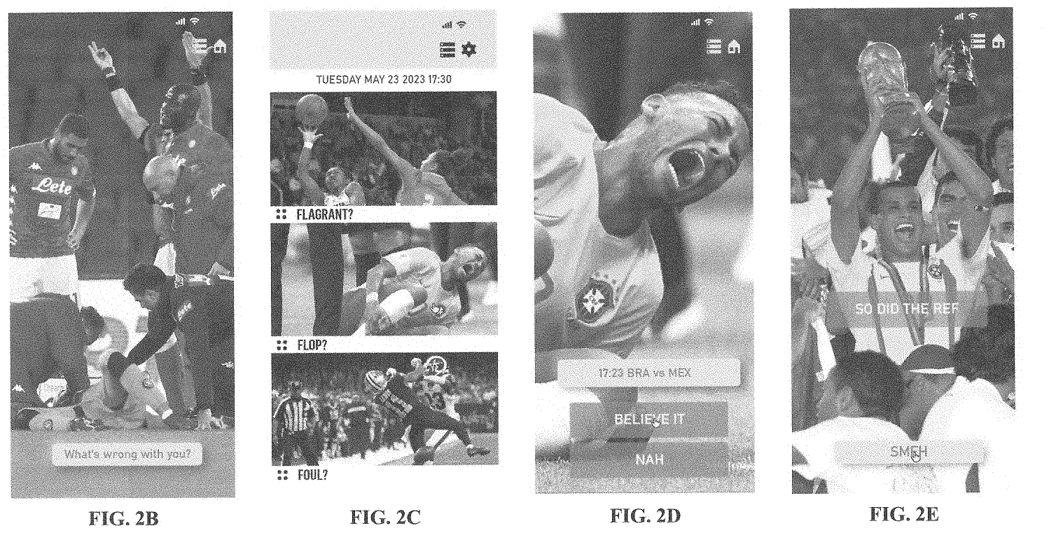

FIGS. 2A through 2E show a system 100 (e.g., an event rating system, a crowdsourced event rating network, a system for exchanging crowdsourcing data, or the like) in which one or more methodologies or technologies can be implemented such as, for example, rating specific occurrences at sporting events, or the like. In an embodiment, the system 100 includes a device 102 including a visual display 262 for displaying event information. In an embodiment, the device 102 includes a virtual controller 264 configured to receive one or more inputs associated with an event, control the visual display 262, control the device 102, and the like. In an embodiment, the device 102 includes one or more menus 266, 268 configured to generate a user interface presenting a rating menu and receive one or more inputs indicative of a rating associated with the event based on the rating menu. In an embodiment, the device 102 includes user rate component 270 configured to generate event rating information based on receiving the one or more inputs indicative of the rating associated with the event. In an embodiment, the device 102 includes a pushed information component 270 configured to generate pushed information, pushed notices, pushed crowdsourced information and the like. In an embodiment, the device 102 includes an event rating information component 272 configured to generate event rating information based on receiving the one or more inputs indicative of the rating associated with the event. In an embodiment, the device 102 includes an interface 274 configured to generate embellishment data responsive to receiving one or more inputs associated with the sporting event.

In an embodiment, the system 100 includes a crowdsource event module configured to generate a user interface presenting a crowdsourced event menu and to receive one or more inputs indicative of an assessment associated with an event. In an embodiment, the crowdsource event module includes hardware and software configured to generate a user interface presenting the crowdsourced event menu to permit user selection of an event from one or more events and to receive and store one or more inputs associated with an event based on one or more user selections.

In an embodiment, a module includes hardware, software components, or any combination thereof. In an embodiment, one or more of the modules take the form of hardware components (e.g., inductors, capacitors, switches, solid state components, photocells, etc.) located onboard or offboard. In an embodiment, one or more of the modules take the form of computer code modules (e.g., executable code, object code, source code, script code, machine code, etc.) configured for execution by an onboard or offboard processor.

In an embodiment, the system 100 includes an event classifier module configured to generate crowdsourced classification information based on receiving the one or more inputs indicative of the assessment associated with the event. In an embodiment, the event classifier module is configured to acquire and store one or more assessments from the plurality of remote devices each configured to receive one or more inputs indicative of an assessment associated with an event and configured to generate crowdsourced classification information based on the acquired one or more assessments. In an embodiment, the event classifier module includes hardware and software configured to generate crowdsourced classification information indicative of one or more crowdsourced assessments associated with the event.

In an embodiment, the system 100 includes a virtual display module configured to generate a virtual representation of the crowdsource classification information associated with the event.

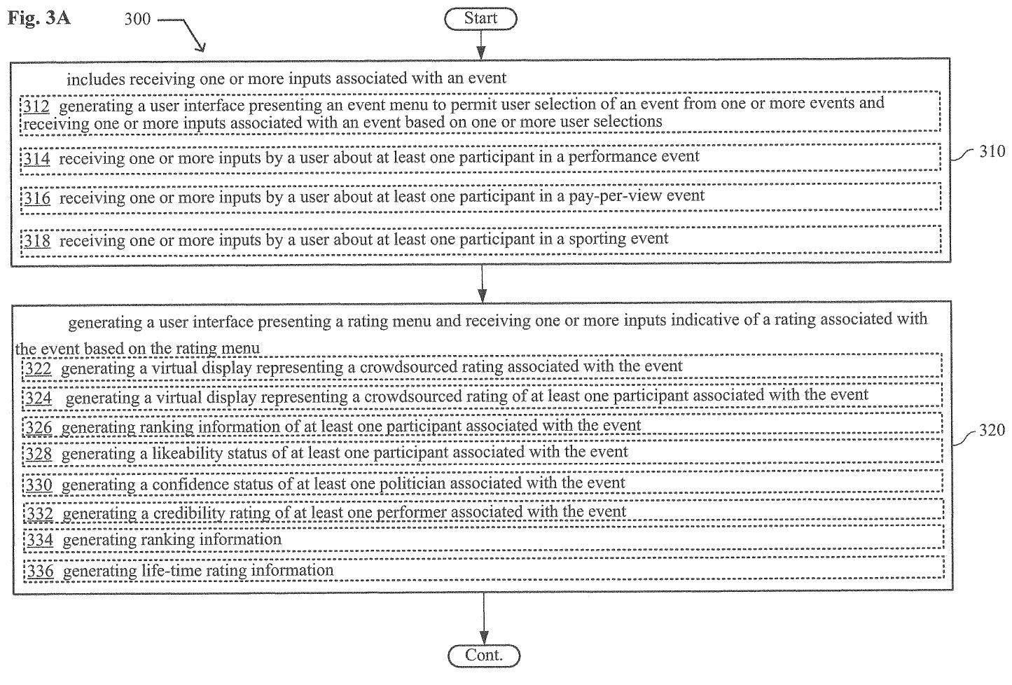

FIGS. 3A and 3B show a method 300 to allow users to rate specific occurrences of an event. At 310, the method 300 includes receiving one or more inputs associated with an event. At 312, receiving the one or more inputs associated with an event includes generating a user interface presenting an event menu to permit user selection of an event from one or more events and receiving one or more inputs associated with an event based on one or more user selections. At 314, receiving the one or more inputs associated with an event includes receiving one or more inputs by a user about at least one participant in a performance event. At 316, receiving the one or more inputs associated with an event includes receiving one or more inputs by a user about at least one participant in a pay-per-view event. At 318, receiving the one or more inputs associated with an event includes receiving one or more inputs by a user about at least one participant in a sporting event.

At 320, the method 300 includes generating a user interface presenting a rating menu and receiving one or more inputs indicative of a rating associated with the event based on the rating menu. At 322, generating the event rating information includes generating a virtual display representing a crowdsourced rating associated with the event. At 324, generating the event rating information includes generating a virtual display representing a crowdsourced rating of at least one participant associated with the event. At 326, generating the event rating information includes generating ranking information of at least one participant associated with the event. At 328, generating the event rating information includes generating a likeability status of at least one participant associated with the event. At 330, generating the event rating information includes generating a confidence status of at least one politician associated with the event. At 332, generating the event rating information includes generating a credibility rating of at least one performer associated with the event. At 334, generating the event rating information includes generating ranking information. At 336, generating the event rating information includes generating life-time rating information.

At 340, the method 300 includes generating event rating information based on receiving the one or more inputs indicative of the rating associated with the event. At 350, the method 300 includes exchanging event rating information with a remote network. At 360, the method 300 includes receiving crowdsourced event rating information associated with a plurality of users from a remote network, enterprise server, client device, or the like. At 370, the method 300 includes generating a display indicative of crowdsourced event rating information based on receiving crowdsourced event rating information associated with a plurality of users from the remote network.

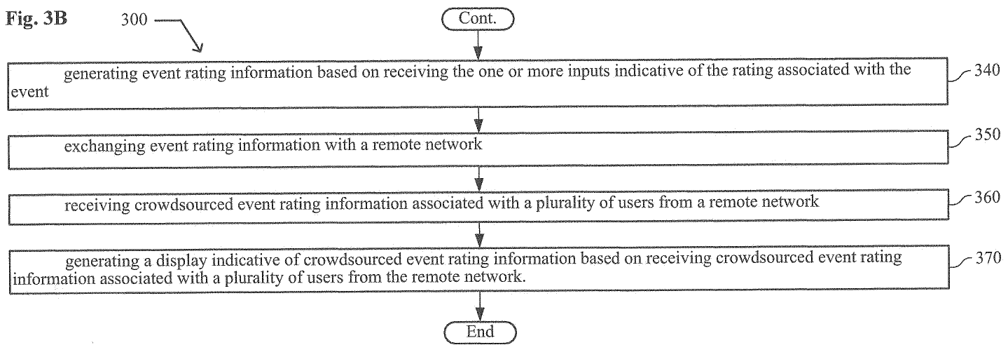

FIG. 4 shows a method 400. At 410, the method 400 includes receiving one or more inputs associated with a sporting event. At 412, receiving the one or more inputs associated with the sporting event includes receiving one or more inputs by a user about at least one participant in the sporting event. At 414, receiving the one or more inputs associated with the sporting event includes receiving one or more inputs associated with at least one participant in the sporting event. At 416, receiving the one or more inputs associated with the sporting event includes receiving one or more inputs associated with at least one player participating in the sporting event. At 418, receiving the one or more inputs associated with the sporting event includes receiving one or more inputs indicative of an event rating based on a scale presented by a client application. At 419 receiving the one or more inputs associated with the sporting event includes receiving one or more inputs by a user indicative of an embellishment rating of a player participating in the sporting event based on a scale presented by a client application.

At 420, the method 400 includes generating embellishment data responsive to receiving one or more inputs associated with the at least one participant in a sporting event. At 430, the method 400 includes exchanging embellishment data with a remote network. At 432, exchanging the embellishment data with the remote network includes exchanging at least one of faking level information, shame rating information, embellishment score information, flopper information, and wuss status information associated with the at least one participant in the sporting event.

At 440, the method 400 includes generating a virtual display representing an embellishment status of at least one participant associated with the sporting event. At 442, generating the virtual display representing the embellishment status of at least one participant associated with the sporting event includes generating the virtual display representing the embellishment status responsive to exchanging embellishment data with the remote network. At 444, generating the virtual display representing the embellishment status of at least one participant associated with the sporting event includes generating a virtual display indicative of at least one of faking level information, shame rating information, embellishment score information, flopper information, and wuss status information associated with the at least one participant the sporting event. At 446, generating the virtual display representing the embellishment status of at least one participant associated with the sporting event includes generating a virtual display representing at least one of a faking level, a shame rating, an embellishment score, a flopper status, and a wuss status associated with the at least one participant in the sporting event.

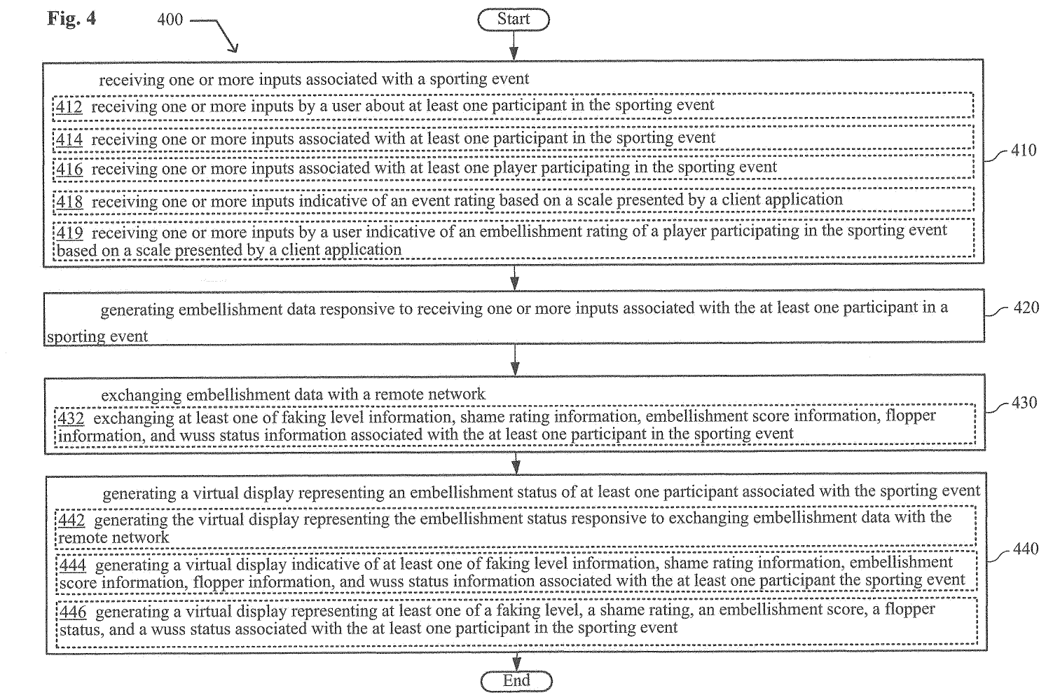

FIG. 5 shows an interactive method 500 for allowing users to rate specific occurrences during a broadcasted event. At 510, the method 500 includes receiving crowdsourcing data from a plurality of remote devices. At 512, receiving crowdsourcing data from the plurality of remote devices includes receiving embellishment scores. At 514, receiving crowdsourcing data from the plurality of remote devices includes receiving embellishment rating of a player, a referee, an umpire, an official, a manager, a coach, or a trainer participating in the sporting event based on a scale presented by a client application. At 516, receiving crowdsourcing data from the plurality of remote devices includes receiving faking level information, shame rating information, embellishment score information, flopper information, and wuss status information associated with the at least one participant in the sporting event.

At 520, the method 500 includes generating embellishment data using the crowdsourced data. At 530, the method 500 includes exchanging embellishment data with one or more remote devices.

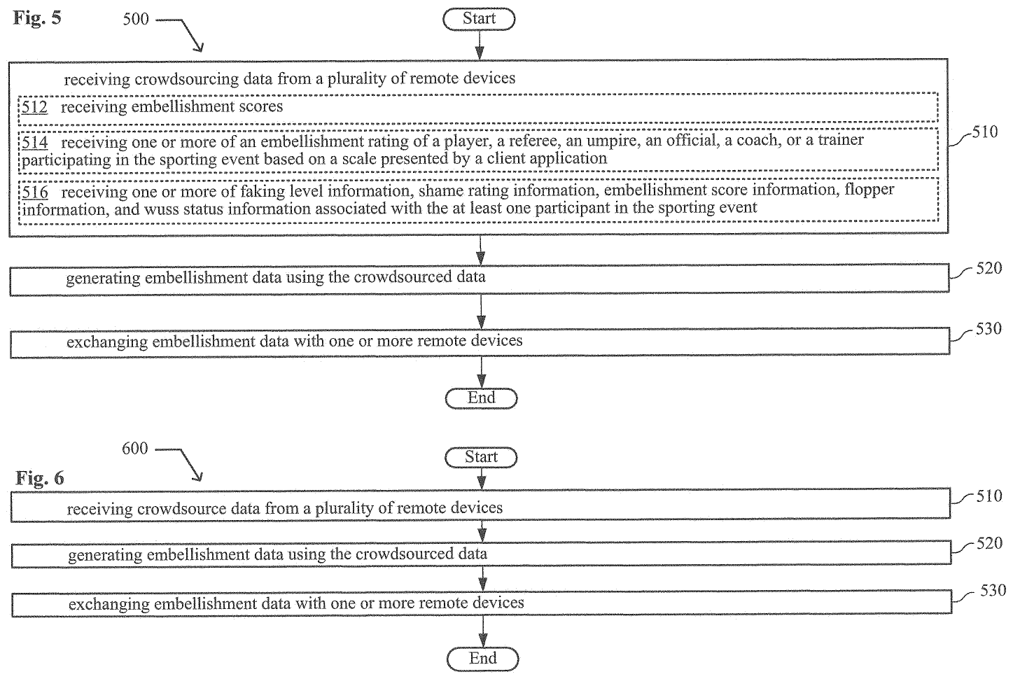

FIG. 6 shows an interactive a method 600 of rating specific occurrences at sporting events. At 610, the method 600 includes receiving crowdsource data from a plurality of remote devices. At 620, the method 600 includes generating embellishment data using the crowdsourced data. At 630, the method 600 includes exchanging embellishment data with one or more remote devices.

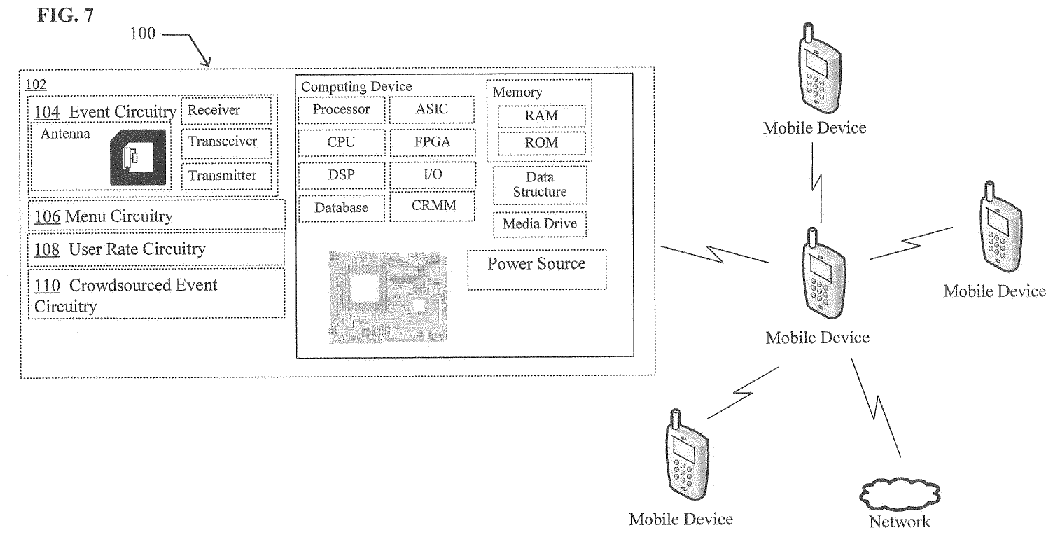

FIG. 7 shows a system 100 (e.g., an event rating system, a crowdsourced event rating network, a system for receiving crowdsourcing data from a plurality of remote devices, or the like) in which one or more methodologies or technologies can be implemented such as, for example, rating specific occurrences at sporting events, or the like. In an embodiment, the system 100 includes a device 102 including event circuitry 104 configured to receive one or more inputs associated with an event. In an embodiment, a user device is operably coupled to one or more device operated by other users. In an embodiment during operation, the system is configured to permit users to interact with other users and rate specific occurrences during a broadcasted event.

In an embodiment, the system 100 includes computing circuitry configured to examine digital content (e.g., video, images, etc.) associated with an event and to generate event rating information. For example, in an embodiment, the system 100 includes computing circuitry configured to classify digital content (e.g., video, images, etc.) and to generate one or more of faking level information, shame rating information, embellishment score information, flopper information, or wuss status information based on the classification.

In an embodiment, the system 100 includes computing circuitry configured to classify digital content one frame at a time using a convolutional neural network (CNN). In an embodiment, digital content is classified using a time-distributed CNN and passing the features to a recurrent neural network (RNN). In an embodiment, the system 100 includes computing circuitry configured to classify digital content using a three-dimensional convolutional network.

In an embodiment, the system 100 includes computing circuitry configured to extract features from each frame using a CNN and passing the sequence to a recurrent neural network (RNN). For example, in an embodiment, the system 100 includes computing circuitry configured to extract features associated with a faking a foul, an injury, or the like; a shame feature; an embellishment; a flopper feature; a wuss feature; of the like. In an embodiment, the system 100 includes computing circuitry configured to extract features from each frame with a CNN and passing the sequence to a multilayer perceptron (MLP).

In an embodiment, the system 100 includes menu circuitry 106 configured to generate a user interface presenting a rating menu and receive one or more inputs indicative of a rating associated with the event based on the rating menu. In an embodiment, the system 100 includes user rate circuitry 108 configured to generate event rating information based on receiving the one or more inputs indicative of the rating associated with the event. In an embodiment, the system 100 includes crowdsourced event circuitry 110 configured to receive crowdsourced event rating information associated with a plurality of users from a remote network. In an embodiment, the crowdsourced event circuitry is configured to exchange event rating information with a remote network.

In an embodiment, a method includes applying a deep learning classifier to event digital content to obtain prediction scores for the presence of embellishment features of a participant captured in the event digital content. In an embodiment, applying the deep learning classifier to the event digital content to obtain prediction scores for the presence of embellishment features of a participant captured in the event digital content includes applying a deep learning classifier to event digital content to obtain pixel-wise prediction scores for the presence of embellishment features of a participant captured in the event digital content. In an embodiment, applying the deep learning classifier to the event digital content to obtain prediction scores for the presence of embellishment features of a participant captured in the event digital content includes classifying digital content one frame at a time using a convolutional neural network (CNN) to extract embellishment features of the participant captured in the event digital content.

In an embodiment, the deep learning classifier to the event digital content to obtain prediction scores for the presence of embellishment features of a participant captured in the event digital content includes classifying digital content by applying a time-distributed convolutional neural network (CNN) and passing the features to a recurrent neural network (RNN),In an embodiment, applying the deep learning classifier to the event digital content to obtain prediction scores for the presence of embellishment features of a participant captured in the event digital content includes classifying digital content by extracting features from each frame with a convolutional neural network (CNN) and passing the features to a multilayer perceptron (MLP). In an embodiment, applying the deep learning classifier to the event digital content to obtain prediction scores for the presence of embellishment features of a participant captured in the event digital content includes classifying digital content using a three-dimensional convolutional network.

In an embodiment, a method includes generating a virtual representation of embellishment data based on the prediction scores for the presence of embellishment features. In an embodiment, generating the virtual representation of embellishment data based on the prediction scores for the presence of embellishment features includes generating a virtual representation of a faking level, a shame rating, an embellishment score, a flopper level, or a wuss status. In an embodiment, generating the virtual representation of embellishment data based on the prediction scores for the presence of embellishment features includes generating a virtual representation of a level, status, or score associated with an embellishment feature captured in the event digital content.

In an embodiment, generating the virtual representation of embellishment data based on the prediction scores for the presence of embellishment features includes generating a virtual representation of a lifetime embellishment level, a lifetime embellishment status, or a lifetime embellishment score associated with a participant captured in the event digital content. In an embodiment, generating the virtual representation of embellishment data based on the prediction scores for the presence of embellishment features includes generating one or more instances of faking level information, shame rating information, embellishment score information, flopper information, or wuss status information based on the classification based on the prediction scores for the presence of embellishment features.

In an embodiment, the system 100 includes an embellishment prediction unit including computational circuitry configured to apply a deep learning classifier to generate prediction scores for a presence of embellishment features of a participant captured in an event digital content. In an embodiment, the embellishment prediction unit including computational circuitry configured to apply a deep learning classifier to generate prediction scores for a presence of embellishment features of a participant captured in an event digital content includes computational circuitry configured to apply a convolutional neural network (CNN) to generate prediction scores for a presence of embellishment features of a participant captured in an event digital content. In an embodiment, the embellishment prediction unit including computational circuitry configured to apply a deep learning classifier to generate prediction scores for a presence of embellishment features of a participant captured in an event digital content includes computational circuitry configured to apply a time-distributed convolutional neural network (CNN) and passing the features to a recurrent neural network (RNN) to classify embellishment features captured in the event digital content.

In an embodiment, the embellishment prediction unit including computational circuitry configured to apply a deep learning classifier to generate prediction scores for a presence of embellishment features of a participant captured in an event digital content includes computational circuitry configured to apply a three-dimensional convolutional network. to extract embellishment features of the participant captured in the event digital content. In an embodiment, the embellishment prediction unit including computational circuitry configured to apply a deep learning classifier to generate prediction scores for a presence of embellishment features of a participant captured in an event digital content includes computational circuitry configured to apply a convolutional neural network (CNN) and passing the features to a multilayer perceptron (MLP) to extract embellishment features of the participant captured in the event digital content.

In an embodiment, the system 100 includes a wuss prediction unit including computational circuitry configured to generate a virtual display of embellishment data based on the prediction scores for the presence of embellishment features. In an embodiment, the wuss prediction unit including computational circuitry configured to generate the virtual display of embellishment data based on the prediction scores for the presence of embellishment features includes computational circuitry configured to generate a virtual representation of a faking level, a shame rating, an embellishment score, a flopper level, or a wuss status.

In an embodiment, the wuss prediction unit including computational circuitry configured to generate the virtual display of embellishment data based on the prediction scores for the presence of embellishment features includes computational circuitry configured to generate a virtual representation of one or more instances of faking level information, shame rating information, embellishment score information, flopper information, or wuss status information. In an embodiment, the wuss prediction unit including computational circuitry configured to generate the virtual display of embellishment data based on the prediction scores for the presence of embellishment features includes computational circuitry configured to generate a virtual representation of a virtual representation of a lifetime embellishment level, a lifetime embellishment status, or a lifetime embellishment score associated with a participant captured in the event digital content.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include, but are not limited to, physically mateable, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the type of signal-bearing medium used to carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), the various operations may be performed in orders other than those that are illustrated or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A system, comprising:
a crowdsource event module configured to generate a user interface presenting a crowdsourced event menu and to receive one or more inputs indicative of an assessment associated with an event; and
an event classifier module configured to generate crowdsourced classification information based on receiving the one or more inputs indicative of the assessment associated with the event.

2. The system of claim 1, wherein the crowdsource event module includes hardware and software configured to generate a user interface presenting the crowdsourced event menu to permit user selection of an event from one or more events and to receive and store one or more inputs associated with an event based on one or more user selections.

3. The system of claim 1, wherein the event classifier module is configured to acquire and store one or more assessments from the plurality of remote devices each configured to receive one or more inputs indicative of an assessment associated with an event, and configured to generate crowdsourced classification information based on the acquired one or more assessments.

4. The system of claim 1, wherein the event classifier module includes hardware and software configured to generate crowdsourced classification information indicative of one or more crowdsourced assessments associated with the event.

5. The system of claim 1, further comprising:
a virtual display module configured to generate a virtual representation of the crowdsource classification information associated with the event.

6. A method to allow users to rate specific occurrences of an event, comprising receiving one or more inputs associated with an event;
generating a user interface presenting a rating menu and receiving one or more inputs indicative of a rating associated with the event based on the rating menu; and
generating event rating information based on receiving the one or more inputs indicative of the rating associated with the event.

7. The method of claim 6, further comprising:
exchanging event rating information with a remote network.

8. The method of claim 6, further comprising:
receiving crowdsourced event rating information associated with a plurality of users from a remote network.

9. The method of claim 8, further comprising:
generating a display indicative of crowdsourced event rating information based on receiving crowdsourced event rating information associated with a plurality of users from the remote network.

10. The method of claim 6, wherein receiving the one or more inputs associated with an event includes generating a user interface presenting an event menu to permit user selection of an event from one or more events and receiving one or more inputs associated with an event based on one or more user selections.

11. The method of claim 6, wherein receiving the one or more inputs associated with an event includes receiving one or more inputs by a user about at least one participant in an event.

12. The method of claim 6, wherein receiving the one or more inputs associated with an event includes receiving one or more inputs by a user about at least one participant in a sporting event.

13. The method of claim 6, wherein generating the event rating information includes generating a virtual display representing a crowdsourced rating associated with the event.

14. The method of claim 6, wherein generating the event rating information includes generating a virtual display representing a crowdsourced rating of at least one participant associated with the event.

15. The method of claim 6, wherein generating the event rating information includes generating ranking information of at least one participant associated with the event.

16. The method of claim 6, wherein generating the event rating information includes generating ranking information.

17. The method of claim 6, wherein generating the event rating information includes generating life-time ranking information.

18. A device, comprising:
event circuitry configured to receive one or more inputs associated with an event;
menu circuitry configured to generate a user interface presenting a rating menu and receive one or more inputs indicative of a rating associated with the event based on the rating menu; and
user rate circuitry configured to generate event rating information based on receiving the one or more inputs indicative of the rating associated with the event.

19. The device of claim 18, further comprising:
crowdsourced event circuitry configured to receive crowdsourced event rating information associated with a plurality of users from a remote network.

20. The device of claim 18, further comprising:
crowdsourced event circuitry configured to exchange event rating information with a remote network.
